(19) United States
(12) Patent Application Publication
(10) Pub. No.: US 2014/0162637 A1
(43) Pub. Date: Jun. 12, 2014

(54) METHOD AND APPARATUS FOR SELECTIVE DISCOVERY USING CUSTOMER CATEGORY IN DEVICE TO DEVICE COMMUNICATION SERVICE

(71) Applicant: Electronics and Telecommunications Research Institute, Daejeon (KR)

(72) Inventors: Woo Goo PARK, Daejeon (KR); Dae Ik KIM, Daejeon (KR); Jee Hyeon NA, Daejeon (KR); Nam Hoon PARK, Daejeon (KR)

(73) Assignee: Electronics and Telecommunications Research Institute, Daejeon (KR)

(21) Appl. No.: 14/097,961

(22) Filed: Dec. 5, 2013

(30) Foreign Application Priority Data
Dec. 6, 2012 (KR) 10-2012-0140783

(51) Int. Cl. H04W 8/00; H04W 76/02

(52) U.S. Cl. CPC H04W 8/005; H04W 76/023
USPC 455/434

(57) ABSTRACT

A method and an apparatus for selective discovery using a customer category in a device-to-device (D2D) communication service is disclosed. A method of selectively discovering service providing devices that provide services via D2D communication using a mobile communication network includes receiving, by a server for managing information about the service providing devices, information about a user equipment from the user equipment, verifying whether the user equipment corresponds to a preset customer category using the received information about the user equipment based on a service customer category table including information about a customer category that is the information about the user equipment provided with the services of the service providing devices, and selectively transmitting information about the services provided by the service providing devices to the user equipment based on a verification result.

### CROSS-REFERENCE TO RELATED APPLICATION

This application claims priority to and the benefit of Korean Patent Application No. 10-2012-0140783, filed on Dec. 6, 2012, in the Korean Intellectual Property Office, the disclosure of which is incorporated herein by reference.

### BACKGROUND

1. Field of the Invention

The present invention relates to a method and an apparatus for a device-to-device (D2D) service customer or D2D user equipment (UE) to selectively discover a D2D service provider for a D2D communication service in a cellular mobile communication system.

2. Description of the Related Art

As mobile communication devices capable of providing a diversity of new services, such as smart phones, smart pads and tablet PCs, are rapidly popularized, data traffic in a cellular mobile communication system increases accordingly. If machine-to-machine (M2M) communication using machines, including people-to-machine and machine-to-machine communication, as a new mobile market widely spread beyond people-to-people communication, traffic to a base station is expected to increase uncontrollably.

Accordingly, a device-to-device (D2D) communication between cellular mobile communication devices based on proximity is regarded as a method to improve performance of existing mobile communication networks with reduced costs. D2D communication technology using a cellular mobile communication system enables direct transmission of data traffic between devices without a relay of a base station, thus reducing not only use of wireless resources but also entire traffic in the cellular mobile communication network.

As technology for D2D communication, KR Patent Publication No. 10-2012-0100833, published on Sep. 12, 2012, discloses “Direct communication execution method and terminal supporting the same,” in which a first terminal directly communicates with a second terminal using a common direct communication resource communally allocated to all cells and having a fixed size and location.

Meanwhile, such a proximity-based D2D service has various scenarios. The D2D service is classified into a D2D service involving control of a base station over a cellular mobile communication network and a D2D service without control of the base station for public safety in a region where communication with the base station is impossible due to natural disaster. The D2D service involving the control of the base station includes a service providing direct communication between two terminals having a connection, for example, a D2D service providing continuity of a service by changing from a cellular communication to a D2D communication when two communicating terminals approach each other and a D2D service finding a neighboring friend of a user and connecting the user and the friend via D2D, and a service providing direct communication between terminals having no connections, for example, a D2D local advertising service and a D2D local personal broadcasting service. Here, a plurality of D2D service providers that provides D2D local advertising services and D2D local personal broadcasting services may exist in a service area of the base station, and a terminal wishing to receive a relevant D2D service needs an ability to discover the service.

However, the D2D service providers wish to have different strategies for individual customers by providing distinguished services, for example, providing more benefits to loyal customers, in order to conduct effective business activities and increase sales in practice.

Therefore, a method of selectively discovering a service provided by a service provider for each customer is required in discovering D2D local advertising services or D2D local personal broadcasting services provided by a plurality of unspecified service providers in a cellular mobile communication system.

### SUMMARY

An aspect of the present invention provides a method and an apparatus for selective discovery using a customer category in a device-to-device (D2D) communication service capable of selectively discovering a service, which a service provider provides, by each customer.

Another aspect of the present invention also provides a method and an apparatus for selective discovery using a customer category in a D2D communication service capable of reducing battery consumption of a user equipment in discovery.

Still another aspect of the present invention also provides a method and an apparatus for selective discovery using a customer category in a D2D communication service capable of providing a customized service for a category of each customer.

According to an aspect of the present invention, there is provided a method of selectively discovering service providing devices that provide services via D2D communication using a mobile communication network, the method including: a server for managing information about the service providing devices, receiving information about a user equipment from the user equipment; verifying whether the user equipment corresponds to a preset customer category using the received information about the user equipment based on a service customer category table including information about a customer category that is the information about the user equipment provided with the services of the service providing devices; and selectively transmitting information about the services provided by the service providing devices to the user equipment based on a verification result.

The service customer category table may include the information about the customer category and customer activity information that is information about an activity of the user equipment.

The information about the customer category may be updated by each service providing device.

The information about the user equipment may include an identifier of a base station to which the user equipment connects and an identifier of the user equipment.

The verifying may include verifying a service providing device being in connection to the base station based on the identifier of the base station, and verifying whether the identifier of the user equipment corresponds to the preset customer category based on the information about the customer category received from the verified service providing device.

The transmitting may include transmitting, to the user equipment, information about a service provided by a service providing device other than a predetermined service providing device among the verified service providing devices when the identifier of the user terminal is set up as the preset customer category in information about a customer category received from the predetermined service providing device.

According to an aspect of the present invention, there is provided a method of selectively discovering a service providing device that provides a service via D2D communication using a mobile communication network, the method including: the service providing device transmitting information about the service provided by the service providing device to a server for managing information about the service providing device; receiving, from the server, an identifier allocated to the service and information about a customer category that is information about a user equipment provided with the service; being allocated a wireless resource for providing the service from a base station based on the received identifier; determining a service to be provided to the user equipment based on the information about the customer category when a service request is received from the user equipment; and providing the determined service to the user equipment based on the allocated resource.

According to an aspect of the present invention, there is provided an apparatus for selectively discovering information about service providing devices that provide services via D2D communication using a mobile communication network, the apparatus including: a reception unit to receive information about a user equipment from the user equipment; a verification unit to verify whether the user equipment corresponds to a preset customer category using the received information about the user equipment based on a service customer category table comprising information about a customer category that is the information about the user equipment provided with the services of the service providing devices; and a transmission unit to selectively transmit information about the services provided by the service providing devices to the user equipment based on a verification result.

According to an aspect of the present invention, there is provided an apparatus for selectively discovering a service provided via D2D communication using a mobile communication network, the apparatus including: a communication unit to transmit information about the service to a server for managing information about a service providing device providing the service via D2D communication using the mobile communication network, and receiving, from the server, an identifier allocated to the service and information about a customer category that is information about a user equipment provided with the service; an allocation unit to be allocated a wireless resource for providing the service from a base station based on the received identifier; a determination unit to determine a service to be provided to the user equipment based on the information about the customer category when a service request is received from the user equipment; and a providing unit to provide the determined service to the user equipment based on the allocated resource.

As described above, according to aspects of the present invention, when a service request is made from a user equipment using a D2D service, information about services provided by service providing devices may be selectively transmitted based on a service customer category table, thereby selectively discovering a service, which a service provider provides, by each customer.

Further, when a service request is made from a user equipment using a D2D service, information about a service of a D2D service provider that does not wish to provide a service to a predetermined customer may be excluded from transmission to a user equipment of the predetermined customer, thereby reducing battery consumption of the user equipment in discovery.

In addition, a service may be provided based on a customer category for a user equipment using a D2D service, thereby providing a customized service for a category of each customer.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a local advertising service via device-to-device (D2D) communication in a cellular mobile communication system according to an exemplary embodiment of the present invention;

FIG. 2 is a flowchart illustrating a process in which a D2D service provider registers a service and is allocated a wireless resource in a cellular mobile communication system according to an exemplary embodiment of the present invention;

FIG. 3 illustrates a D2D service customer category table according to an exemplary embodiment of the present invention;

FIG. 4 is a flowchart illustrating a process in which a D2D service customer acquires information about an interesting D2D service in a cellular mobile communication system according to an exemplary embodiment of the present invention;

FIG. 5 is a block diagram a D2D server for selectively discovering information about service providing devices that provide services via D2D communication using a mobile communication network according to an exemplary embodiment of the present invention;

FIG. 6 is a flowchart illustrating a process in which a D2D service provider provides a service requested by a D2D service customer in a cellular mobile communication system according to an exemplary embodiment of the present invention;

FIG. 7 illustrates a D2D service customer category transition table for reference to change a customer category of a D2D service customer according to an exemplary embodiment of the present invention; and

FIG. 8 is a block diagram illustrating a D2D service providing device for selectively discovering a service provided via D2D communication using a mobile communication network according to an exemplary embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, exemplary embodiments of the present invention will be described in detail with reference to the accompanying drawings.

Throughout the present specification, a base station and an evolved node base (eNB) may be interchangeably used.

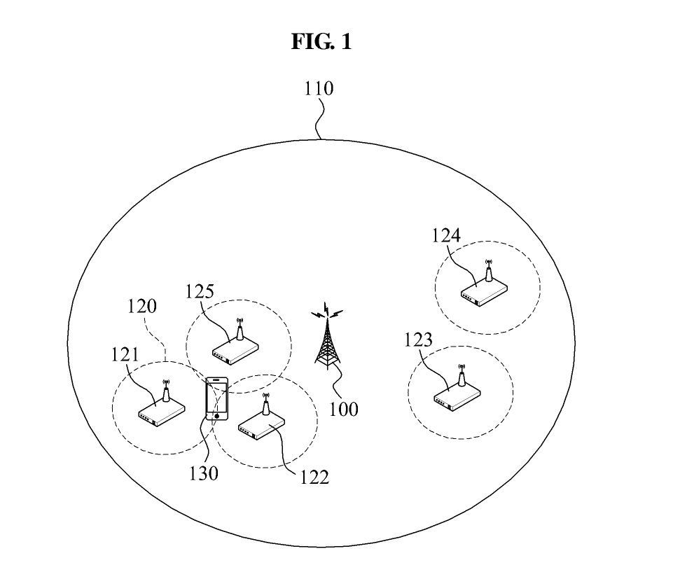

FIG. 1 illustrates a local advertising service via device-to-device (D2D) communication in a cellular mobile communication system according to an exemplary embodiment of the present invention. Hereinafter, the present embodiment will be described with reference to a case where a first D2D service provider (SP) 121 advertising clothing, a second D2D SP 122 advertising a coffee shop, a third D2D SP 123 advertising real estate, a fourth D2D SP 124 advertising a supermarket, and a fifth D2D SP 125 advertising a restaurant are present in a service area 110 of a base station 100. Here, the D2D SPs 121 to 125 may provide services at fixed locations and have different service areas 120.

As shown in FIG. 1, when the first D2D SP 121, the second D2D SP 122, and the fifth D2D SP 125 are adjacent to a D2D service customer (D2D user equipment (UE)) 130 to receive a D2D service and the second D2D SP 122 and the third D2D SP 123 are too far from the D2D UE 130 to provide a D2D service, the D2D UE 130 may discover the first D2D SP 121, the second D2D SP 122, and the fifth D2D SP 125 that are near the D2D UE 130. Here, among the D2D SPs 121 to 125, there may exist not only a D2D SP that does not wish to provide an advertisement to all D2D UEs present in an area 120 thereof because of a plurality of practical reasons, for example, obstruction of business and reduction in service maintenance costs, but also a D2D SP that wishes to provide a differentiated advertisement to a predetermined D2D UE so as to offer more benefits.

Thus, when a D2D SP does not wish to provide an advertising service thereof to a predetermined D2D UE, a selective discovery method may be adopted to provide a service for each customer, for example, sending a D2D service list, exclusive of information about the D2D SP, to the predetermined D2D UE or sending discount information or a coupon to the predetermined D2D UE if the D2D UE is a loyal customer.

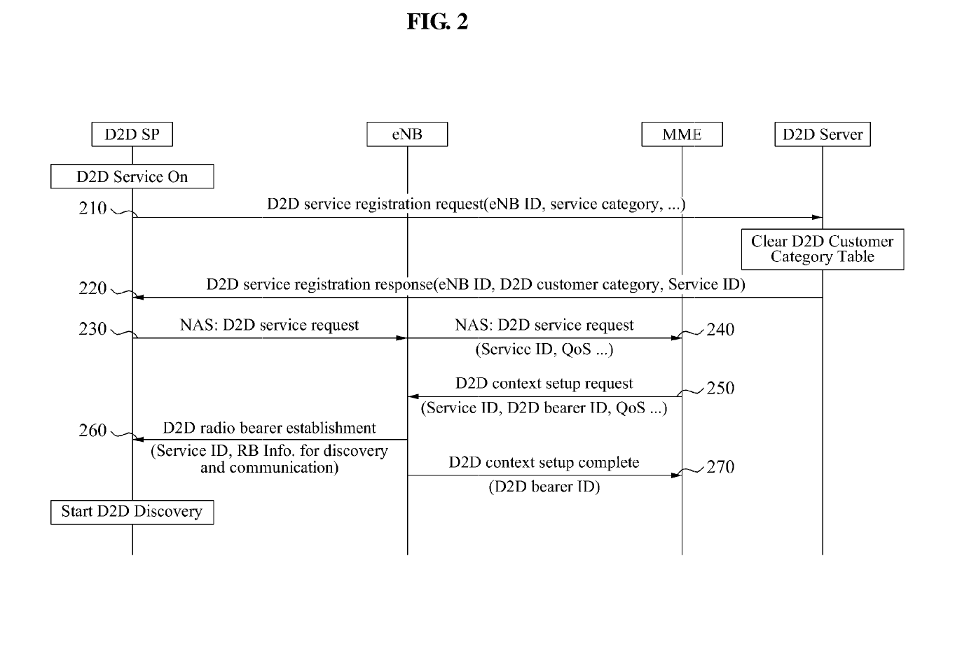

FIG. 2 is a flowchart illustrating a process in which a D2D SP registers a service and is allocated a wireless resource in a cellular mobile communication system according to an exemplary embodiment of the present invention.

As shown in FIG. 2, when a D2D service starts, a service providing device that provides a service via D2D communication using a mobile communication network (hereinafter, referred to as a “D2D SP”) requests registration of the D2D service to be provided by the D2D SP to a D2D server through a D2D service registration request in operation 210. Here, the D2D service registration request may include brief service information, such as an identifier of a base station, for example, an eNB to which the D2D SP currently connects and a service category.

The D2D server, receiving the D2D service registration request, allocates an identifier to the service, initializes a D2D service customer category table, and transmits a D2D service registration response to the D2D SP in operation 220. Here, the D2D service registration response may include information about a customer category and the D2D service identifier. The D2D service identifier may be stored in association with the service category in the D2D server, and be used when a user equipment of a customer of the D2D service (D2D UE, hereinafter, referred to as a “D2D service customer”) requests wireless discovery resource information only with the service category.

The D2D SP, allocated the D2D service identifier, transmits a D2D service request using a non-access stratum (NAS) message to a mobility management entity (MME) through the base station so as to be allocated a wireless discovery resource and a wireless communication resource for the service, the D2D service request including the D2D service identifier and information about quality of service (QoS) needed for the D2D service, in operations 230 and 240.

Then, the MME transmits a D2D context setup request to the base station in order to request establishment of a radio bearer for the D2D service to the base station in operation 250. The D2D context setup request may include the D2D service identifier, a D2D bearer identifier, and the QoS information.

The base station, receiving the D2D context setup request, allocates a wireless discovery resource and a wireless communication resource for the D2D service to the D2D SP, transmits a D2D radio bearer establishment including information about the allocated wireless resources to the D2D SP in operation 260, and transmits a D2D context setup complete to the MME in operation 270.

The D2D SP allocated the wireless discovery resource and the wireless communication resource for the D2D service to provide may broadcast a signal so that the D2D service customer discovers the service through the wireless discovery resource, and may broadcast or multi-cast data of the service through the wireless communication resource.

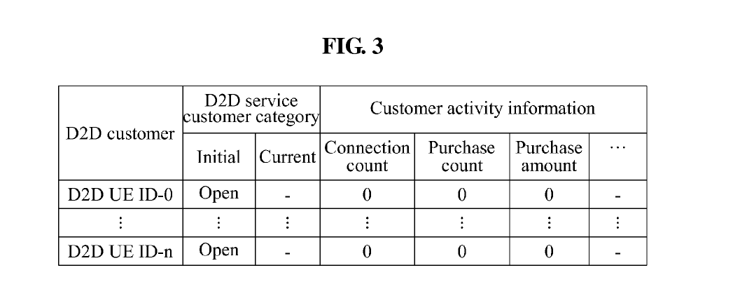

FIG. 3 illustrates a D2D service customer category table according to an exemplary embodiment of the present invention.

When a D2D service customer to be provided with a D2D service connects, a D2D server may store a category of a service to be provided by the customer and connection and sales states of the customer in a D2D customer category table for management of the customer for the next time, as shown in FIG. 3.

The D2D customer category table may store information about a category of each D2D service customer to receive a D2D service as D2D service customer category and information about an activity of the customer as customer activity information.

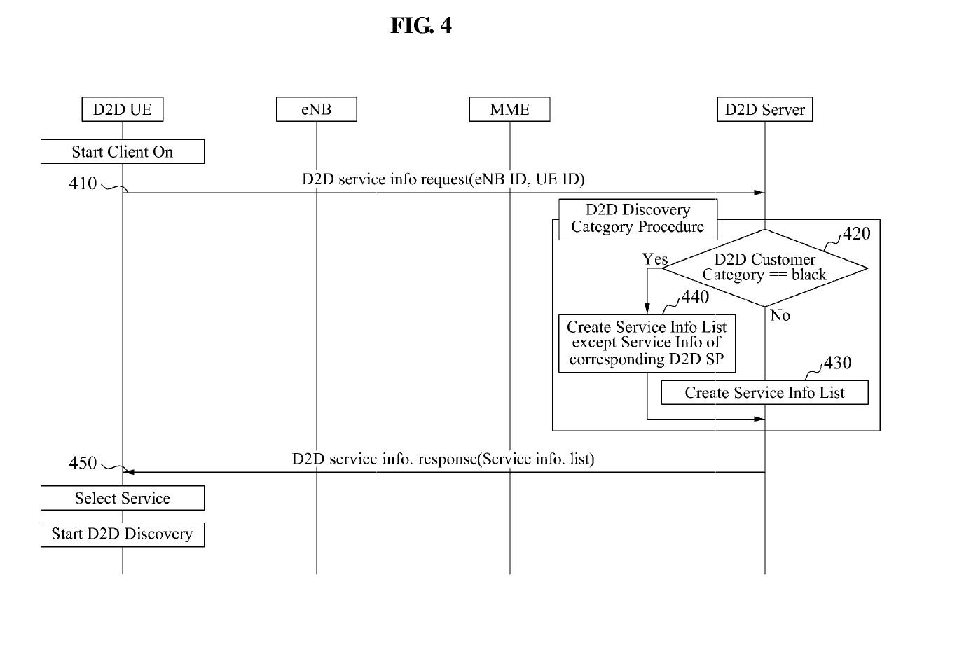

FIG. 4 is a flowchart illustrating a process in which a D2D service customer acquires information about an interesting D2D service in a cellular mobile communication system according to an exemplary embodiment of the present invention.

As shown in FIG. 4, when a D2D service information request is transmitted from a user equipment using a D2D service (D2D UE, hereinafter, referred to as a “D2D service customer”) to a D2D server as a client embedded in the D2D service customer starts in operation 410, the D2D server verifies whether an initial or current value of a service category for the D2D service customer is “Black” based on a D2D service customer category table as in FIG. 3 established based on an advance request by a D2D SP in operation 420, disregarding the initial value in the presence of the current value.

Here, when the initial or current value of the service category for the D2D service customer is not “Black,” the D2D server creates a service information list of services provided from D2D SPs being in connection to a base station of the D2D service customer in operation 430. However, when the initial or current value of the service category for the D2D service customer is “Black,” the D2D server creates a service information list, exclusive of information about a service provided from the D2D SP in operation 440. The D2D server transmits the service information list to the D2D service customer through a D2D service information response in operation 450.

The D2D service customer, receiving the D2D service information response, may select a service to be provided from the received service information list and conduct discovery of the service.

That is, for example, as shown in FIG. 1, when the second D2D SP is set up in advance not to provide a service to the D2D service customer among the three D2D SPs providing services to D2D service customers, that is, the first D2D SP, the second D2D SP and the fifth D2D SP, the D2D server may store an identifier of the D2D service customer in the D2D service customer category table as in FIG. 3 and change an initial or current D2D service customer category to “Black.” In this case, when a D2D service information request is received from the D2D service customer, the D2D server may provide a list of D2D service information about the two D2D SPs, that is, the first D2D SP and the fifth D2D SP, excluding the second D2D SP, to the D2D service customer.

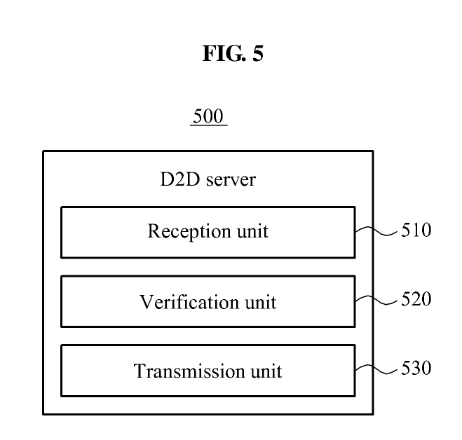

FIG. 5 is a block diagram illustrating a D2D server for selectively discovering information about service providing devices that provide services via D2D communication using a mobile communication network according to an exemplary embodiment of the present invention. Hereinafter, the D2D server 500 for selectively discovering the information about the service providing devices that provide the services via the D2D communication using the mobile communication network will be described in detail with reference to FIG. 5.

The D2D server 500 may include a reception unit 510, a verification unit 520, and a transmission unit 530.

The reception unit 510 receives information about a user equipment (D2D service customer) to receive a service provided from the service providing devices (D2D SPs) from the user equipment. Here, the information about the user equipment may include an identifier of a base station that the user equipment connects to and an identifier of the user equipment.

The verification unit 520 verifies whether the user equipment corresponds to a preset customer category, for example, “Black,” using the information about the user equipment received by the reception unit 510 based on a service customer category table including information about a customer category that is the information about the user equipment provided with the service from the service providing devices as shown in FIG. 3. Here, the service customer category table may include customer activity information that is information about an activity of the user equipment in addition to the information about the customer category. The information about the customer category may be updated by each service providing device.

For example, the verification unit 520 verifies a service providing device being in connection to the base station based on the identifier of the base station to which the user terminal connects and verifies whether the identifier of the user equipment corresponds to the preset customer category based on the information about the customer category received from the verified service providing device.

The transmission unit 530 selectively transmits information about the services provided by the service providing devices to the user equipment based on a verification result.

For example, the transmission unit 530 may create and transmit, to the user equipment, a list of information about a service provided by a service providing device other than a predetermined service providing device among service providing devices identified to be in connection to the base station when the identifier of the user terminal is set up as the preset customer category in information about a customer category received from the predetermined service providing device.

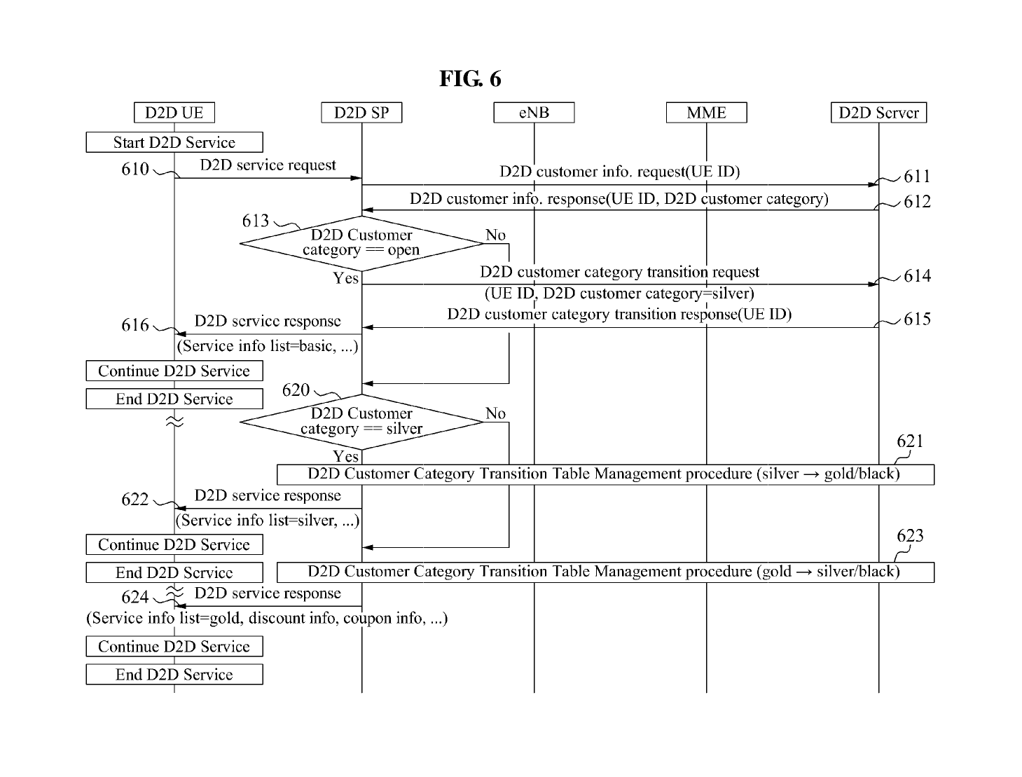

FIG. 6 is a flowchart illustrating a process in which a D2D SP provides a service requested by a D2D service customer in a cellular mobile communication system according to an exemplary embodiment of the present invention.

When a customer receiving a list of D2D service information from a D2D server selects a desired D2D service, a user equipment of the D2D service customer, that is, a D2D UE transmits a D2D service request to a D2D SP in operation 610.

The D2D SP, receiving the service request, judges customer activity information, such as a connection count, a visit count, and a purchase amount of the user, to conduct a process of managing a D2D service customer category.

For example, as shown in FIG. 6, when the D2D service request is received from the D2D UE, the D2D SP transmits a D2D customer information request including an identifier of the UE (UE ID) to the D2D server before providing a service in operation 611 to inquire of the D2D server about a customer category of the UE, and receives information about the customer category of the UE from the D2D server through a D2D customer information response in operation 612.

Here, when the customer category of the UE is “Open” in operation 613, the D2D SP transmits a D2D service response indicating that it is possible to provide a service to the UE in operation 616 and conducts a basic D2D service based on a request from a corresponding customer.

Here, the D2D SP may change the customer category of the UE based on an activity of the UE. FIG. 6 illustrates, for example, that the D2D SP transmits a D2D customer category transition request to request a change of the customer category of the UE to “Silver” to the D2D server in operation 614 and receives a D2D customer category transition response indicating that a change of the customer category of the UE is made from the D2D server in operation 615.

Further, when the customer category of the UE is “Silver” in operation 620, the D2D SP may conduct a process of managing a D2D service customer category table based on customer activity information about the UE to maintain the customer category of the UE as it is, to raise to “Gold,” or to lower to “Black” in operation 621, or provide a D2D service corresponding to “Silver” subsequent to transmitting a D2D service response to the UE in operation 622. Here, when the customer category of the UE is changed to “Black,” the D2D server then excludes information about a service provided by the D2D SP when providing the list of the D2D service information to the user equipment, so that the D2D SP does not provide the D2D service to the customer.

Meanwhile, when the customer category of the UE is “Gold,” the D2D SP may conduct a process of managing the D2D service customer category table based on the customer activity information about the UE to maintain the customer category of the UE as it is or to lower to “Silver” or “Black” in operation 623, or provide a D2D service corresponding to “Gold” subsequent to transmitting a D2D service response to the UE in operation 624. In FIG. 6, the D2D service corresponding to “Gold” includes, for example, discount information and coupon information.

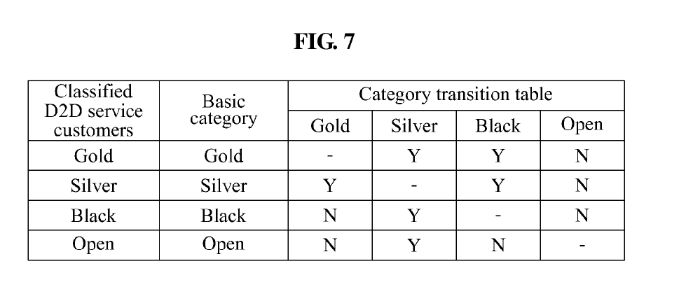

FIG. 7 illustrates a D2D service customer category transition table for reference to change a customer category of a D2D service customer according to an exemplary embodiment of the present invention.

As shown in FIG. 7, the D2D service customer may be classified into, for example, “Gold,” “Silver,” “Black,” and “Open.”

When the customer category of a user equipment of the D2D service customer is “Gold,” a D2D SP may provide differentiated services, such as discount information and coupon information, to the customer. When the customer category is “Silver,” the D2D SP may provide a service corresponding to “Silver” to the customer. However, when the customer category is “Black,” the D2D SP may not receive a service request from the user equipment since a D2D server does not transmit information about a service provided by the D2D SP to the user equipment.

Here, “Open” is set up when the user equipment is first provided with a service from the D2D SP, in which the D2D SP may provide a basic service to the user equipment.

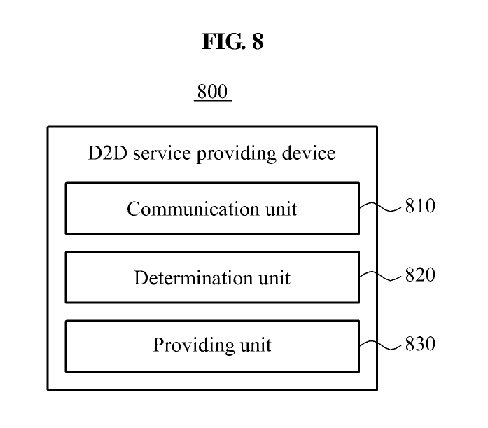

FIG. 8 is a block diagram illustrating a D2D service providing device for selectively discovering a service provided via D2D communication using a mobile communication network according to an exemplary embodiment of the present invention. Hereinafter, the D2D service providing device 800 will be described in detail with reference to FIG. 8.

As shown in FIG. 8, the D2D service providing device 800 may include a communication unit 810, a determination unit 820, and a providing unit 830 in order to selectively discover a service provided via D2D communication using the mobile communication network.

The communication unit 810 transmits information about a service that the device 800 wishes to provide to a D2D server for managing information about a device providing a service via D2D communication using a mobile communication network. Here, the information about the service may include an identifier of a base station that the service providing device connects to and information about a category of the service.

Meanwhile, the communication unit 810 receives an identifier allocated to the service and information about a customer category that is information about a user equipment to be provided with the service from the D2D server. The communication unit 810 is allocated a wireless resource for providing the service from the base station based on the identifier received from the D2D server. To this end, the D2D service providing device 800 may further include an allocation unit, not shown in FIG. 8.

For example, the allocation unit may be allocated a wireless discovery resource for discovering the service and a wireless communication resource for providing the service from the based station that the D2D service providing device 800 connects to based on the identifier received from the D2D server. In this case, the communication unit 810 may broadcast a signal so that the user equipment discovers the service through the wireless discovery resource.

The determination unit 820 determines a service to be provided to the user equipment based on the information about the customer category received from the D2D server when a service request based on the signal broadcasted by the communication unit 810 is received from the user equipment.

Subsequently, the providing unit 830 provides the service determined by the determination unit 820 based on the allocated resource to the allocation unit to the user equipment. Here, the determination unit 820 may change the customer category of the user equipment based on information about an activity of the user equipment.

While the present invention has been shown and described with reference to a few exemplary embodiments and the accompanying drawings, it will be apparent to those skilled in the art that various modifications and variations can be made in the present invention without departing from the spirit or scope of the invention. For example, adequate effects of the present invention may be achieved even if the foregoing processes and methods may be carried out in different order than described above, and/or the aforementioned elements, such as systems, structures, devices, or circuits, may be combined or coupled in different forms and modes than as described above or be substituted or switched with other components or equivalents.

Thus, it is intended that the present invention cover the modifications and variations of this invention provided they come within the scope of the appended claims and their equivalents.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of selectively discovering service providing devices that provide services via device-to-device (D2D) communication using a mobile communication network, the method comprising:
receiving, by a server for managing information about the service providing devices, information about a user equipment from the user equipment;
verifying whether the user equipment corresponds to a preset customer category using the received information about the user equipment based on a service customer category table comprising information about a customer category that is the information about the user equipment provided with the services of the service providing devices; and
selectively transmitting information about the services provided by the service providing devices to the user equipment based on a verification result.

2. The method of claim 1, wherein the service customer category table comprises the information about the customer category and customer activity information that is information about an activity of the user equipment.

3. The method of claim 1, wherein the information about the customer category is updated by each service providing device.

4. The method of claim 1, wherein the information about the user equipment comprises an identifier of a base station to which the user equipment connects and an identifier of the user equipment.

5. The method of claim 4, wherein the verifying comprises:
verifying a service providing device being in connection to the base station based on the identifier of the base station; and
verifying whether the identifier of the user equipment corresponds to the preset customer category based on the information about the customer category received from the verified service providing device.

6. The method of claim 5, wherein the transmitting comprises transmitting, to the user equipment, information about a service provided by a service providing device other than a predetermined service providing device among the verified service providing devices when the identifier of the user terminal is set up as the preset customer category in information about a customer category received from the predetermined service providing device.

7. A method of selectively discovering a service providing device that provides a service via device-to-device (D2D) communication using a mobile communication network, the method comprising:
transmitting, by the service providing device, information about the service provided by the service providing device to a server for managing information about the service providing device;
receiving, from the server, an identifier allocated to the service and information about a customer category that is information about a user equipment provided with the service;
being allocated a wireless resource for providing the service from a base station based on the received identifier;
determining a service to be provided to the user equipment based on the information about the customer category when a service request is received from the user equipment; and
providing the determined service to the user equipment based on the allocated resource.

8. The method of claim 7, wherein the information about the service comprises an identifier of a base station to which the service providing device connects and information about a category of the service.

9. The method of claim 7, wherein the being allocated comprises being allocated a wireless discovery resource for discovering the service and a wireless communication resource for providing the service from the base station based on the received identifier.

10. The method of claim 9, further comprising broadcasting a signal subsequent to the being allocated so that the user equipment discovers the service through the wireless discovery resource.

11. The method of claim 7, further comprising changing the customer category for the user equipment based on information about an activity of the user equipment subsequent to the determining.

12. An apparatus for selectively discovering information about service providing devices that provide services via device-to-device (D2D) communication using a mobile communication network, the apparatus comprising:
a reception unit to receive information about a user equipment from the user equipment;
a verification unit to verify whether the user equipment corresponds to a preset customer category using the received information about the user equipment based on a service customer category table comprising information about a customer category that is the information about the user equipment provided with the services of the service providing devices; and
a transmission unit to selectively transmit information about the services provided by the service providing devices to the user equipment based on a verification result.

13. The apparatus of claim 12, wherein the service customer category table comprises the information about the customer category and customer activity information that is information about an activity of the user equipment.

14. The apparatus of claim 12, wherein the information about the customer category is updated by each service providing device, and the information about the user equipment comprises an identifier of a base station to which the user equipment connects and an identifier of the user equipment.

15. The apparatus of claim 14, wherein the verification unit verifies a service providing device being in connection to the base station based on the identifier of the base station, and verifies whether the identifier of the user equipment corresponds to the preset customer category based on the information about the customer category received from the verified service providing device.

16. The apparatus of claim 15, wherein the transmission unit transmits, to the user equipment, information about a service provided by a service providing device other than a predetermined service providing device among the verified service providing devices when the identifier of the user terminal is set up as the preset customer category in information about a customer category received from the predetermined service providing device.

17. An apparatus for selectively discovering a service provided via device-to-device (D2D) communication using a mobile communication network, the apparatus comprising:
a communication unit to transmit information about the service to a server for managing information about a service providing device providing the service via D2D communication using the mobile communication network, and receiving, from the server, an identifier allocated to the service and information about a customer category that is information about a user equipment provided with the service;
an allocation unit to be allocated a wireless resource for providing the service from a base station based on the received identifier;
a determination unit to determine a service to be provided to the user equipment based on the information about the customer category when a service request is received from the user equipment; and
a providing unit to provide the determined service to the user equipment based on the allocated resource.

18. The apparatus of claim 17, wherein the information about the service comprises an identifier of a base station to which the service providing device connects and information about a category of the service.

19. The apparatus of claim 17, wherein the allocation unit is allocated a wireless discovery resource for discovering the service and a wireless communication resource for providing the service from the base station based on the received identifier, and the communication unit broadcasts a signal so that the user equipment discovers the service through the wireless discovery resource.

20. The apparatus of claim 17, wherein the determination unit changes the customer category for the user equipment based on information about an activity of the user equipment.
